(19) United States
(12) Patent Application Publication
(10) Pub. No.: US 2010/0080915 A1
(43) Pub. Date: Apr. 1, 2010

(54) Film Formation of Mask and Film Formation Method Using the Same

(75) Inventors: Masamichi Masuda, Mobara-shi (JP); Takehiko Soda, Yokohama-shi (JP); Masataka Eida, Mobara-shi (JP); Kazushi Miyata, Mobara-shi (JP)

Correspondence Address: FITZPATRICK CELLA HARPER & SCINTO, 1290 Avenue of the Americas, NEW YORK, NY, 10104-3800, US

(73) Assignees: CANON KABUSHIKI KAISHA, Tokyo (JP); HITACHI DISPLAYS, LTD., Chiba-ken (JP)

(21) Appl. No.: 12/561,602

(22) Filed: Sep. 17, 2009

(30) Foreign Application Priority Data
Sep. 30, 2008 (JP) 2008-251993
Sep. 9, 2009 (JP) 2009-207975

(51) Int. Cl. B05D 1/32; B05C 11/00

(52) U.S. Cl. 427/282; 118/504

(57) ABSTRACT

When a position of a film formation mask is recognized by irradiating the film formation mask with light, an image having a high contrast cannot be obtained, which unstabilizes reproducibility of measurement accuracy for an alignment mark position, leading to an alignment error between a substrate and a mask. Provided is a film formation mask including a mask sheet having a positioning opening and a mask frame, in which a reflective member having a reflectance higher than that of the mask sheet is provided to the positioning opening. When light is irradiated onto the positioning opening of the film formation mask, an intensity difference between light reflected by the mask sheet and light reflected by the reflective member becomes stable. Therefore, the position of the film formation mask may be determined with high reproducibility.

### BACKGROUND OF THE INVENTION

1. Field of the Invention

The present invention relates to a film formation mask and a film formation method using the film formation mask.

2. Description of the Related Art

Hitherto, as a method of producing an organic electroluminescence (EL) display apparatus, there has been adopted a method in which a film formation mask having openings in a predetermined pattern is disposed on a transparent substrate made of, for example, glass so as to be in close contact therewith, thereby forming an electrode film, an organic thin film, or the like in a pattern.

The film formation mask includes a mask sheet that has patterned openings each corresponding to a portion of a substrate on which a film is to be formed, and a mask frame for supporting the mask sheet. In general, the mask sheet is formed of a metal foil which has a small coefficient of thermal expansion, such as a foil made of iron, nickel, or an alloy thereof. Therefore, the mask sheet is prevented from being deformed due to heat during evaporation, and thus suitably employed for forming a film with a high-definition pattern.

A method of aligning a film formation mask with a substrate has been hitherto employed not only for film formation in an organic EL display apparatus but also for a process of producing a semiconductor apparatus. However, in recent years, a high-definition display apparatus has been increasingly developed. As a result, particularly in the production of the organic EL display apparatus, it is required to align the film formation mask with the substrate with high accuracy.

Japanese Patent Application Laid-Open No. H11-158605 discloses an alignment method of observing, with a charge coupled device (CCD) camera, an opening (positioning opening) serving as a mask alignment mark and a substrate alignment mark to detect a positional deviation amount therebetween. In the alignment method, the mask is moved with respect to the substrate such that the positional deviation amount becomes zero, thereby performing the alignment.

An intensity difference between reflected light on the mask and reflected light at the opening serving as the mask alignment mark is recognized as the alignment mark of the mask. According to Japanese Patent Application Laid-Open No. H11-158605, the alignment mark is a mere opening, and hence the light only passes through the opening without being reflected. However, the light that has passed through the opening is reflected by respective members in an apparatus, and the reflected light passes again through the opening, with the result that the reflected light is recognized by the CCD camera. Furthermore, the intensity of the reflected light varies depending on the material or placement of the respective members in the apparatus. As a result, the intensity difference between the reflected light on the mask and the reflected light at the opening serving as the mask alignment mark is not stable, and hence it is difficult to constantly recognize the alignment mark with high accuracy.

Meanwhile, as illustrated in FIG. 6, an apparatus disclosed in Japanese Patent Application Laid-Open No. 2006-176809 includes a CCD camera 301 for recognizing an alignment mark, a mask light source 307, and a reflective plate assembly 304. Light from the mask light source 307 is reflected by the reflective plate assembly 304 so as to illuminate an alignment mark 306 of a mask 303 from an opposite side of the mask 303 with respect to the CCD camera 301. With this structure, an intensity difference between reflected light on the mask 303 and light passing through an opening serving as the alignment mark 306 becomes stable, and therefore the alignment mark 306 may be recognized as a clear image. As a result, by using a substrate alignment mark 305 and the mask alignment mark 306, a substrate 302 and the mask 303 may be aligned with each other with high accuracy.

However, in the case of the alignment method disclosed in Japanese Patent Application Laid-Open No. 2006-176809, a film is attached to a reflection surface of the reflective plate assembly 304 with the elapse of the film formation time. Accordingly, a reflectance of the reflective plate assembly 304 changes, which results in fluctuations of a reflected light amount. As a result, there is a fear that reproducibility of measurement accuracy for an alignment mark position becomes unstable and that an alignment error between the substrate and the mask occurs.

Moreover, through turning around of an evaporation substance during the film formation, a film is attached to the opening serving as the mask alignment mark 306, to thereby change the shape of the alignment mark 306. As a result, there is a fear that deviation of positional information occurs.

### SUMMARY OF THE INVENTION

In order to solve the above-mentioned problems, the present invention provides a film formation mask having openings for forming a film in a pattern on a substrate, including: a mask sheet having openings formed therein; a mask frame for fixing and supporting the mask sheet; a positioning opening provided in the mask sheet; and a reflective member disposed on a surface of the mask sheet, the surface being opposite to another surface thereof that faces the substrate, the reflective member blocking the positioning opening, in which a reflectance of the reflective member is larger than a reflectance of the mask sheet.

According to the present invention, the reflective member is provided to the positioning opening formed in the mask sheet on a surface of the mask sheet, the surface being opposite to another surface thereof that faces the substrate. Therefore, it is possible to suppress a change in reflectance of the mask alignment mark and to stably recognize the mask alignment mark. As a result, the substrate and the mask may be aligned with each other with high accuracy.

Further features of the present invention become apparent from the following description of exemplary embodiments with reference to the attached drawings.

### BRIEF DESCRIPTION OF THE DRAWINGS

FIG. 1 is a schematic perspective view illustrating a film formation mask according to an embodiment of the present invention.

FIG. 2 is a schematic view illustrating a vacuum evaporation apparatus using a film formation mask according to Example 1 of the present invention.

FIG. 3 is a view illustrating an example of a CCD image of a mask mark.

FIG. 4 is a schematic view illustrating a vacuum evaporation apparatus using a film formation mask according to Example 2 of the present invention.

FIG. 5 is a schematic view illustrating a vacuum evaporation apparatus using a film formation mask according to Comparative Example 1 of the present invention.

FIG. 6 is a schematic view illustrating a vacuum evaporation apparatus using a film formation mask according to a conventional example.

### DESCRIPTION OF THE EMBODIMENTS

Preferred embodiments of the present invention will now be described in detail in accordance with the accompanying drawings.

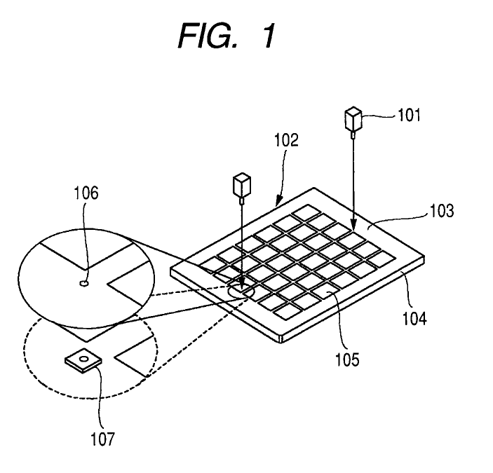

FIG. 1 is a schematic perspective view illustrating a film formation mask according to an embodiment of the present invention. A film formation mask 102 of FIG. 1 is a mask for obtaining thirty-six panels from one large substrate. Each of pattern opening portions 105 corresponds to a display region of one panel. A mask sheet 103 is fixed to and supported by a mask frame 104 in a tensioned state. Multiple vapor passage ports for forming films in a pattern on a substrate are formed in the pattern opening portions 105. Furthermore, multiple positioning openings 106 to be recognized as an alignment mark of the mask are formed in a peripheral region of the mask sheet 103.

Each of the multiple positioning openings 106 serving as the mask alignment mark is provided with a reflective member 107 having a reflectance higher than that of the mask sheet 103. The reflective member 107 is provided on a surface of the mask sheet 103 on a side thereof on which vapor of a film formation substance enters the positioning opening 106, so as to block the positioning opening 106.

The position of the film formation mask 102 may be detected by recognizing the positioning opening 106 as an image through a CCD camera 101. Specifically, light is irradiated onto a vicinity of the positioning opening 106 from a side opposite to the surface of the mask sheet 103 on which the reflective member 107 is provided. Then, light obtained by reflection of the irradiated light by the reflective member 107 and light reflected by the mask sheet 103 are recognized by the CCD camera 101, and an intensity difference between the two lights is recognized as a mask alignment mark image. In a case where the film formation mask and a substrate are aligned with each other, a center position of the mask alignment mark image and a center position of a substrate alignment mark image are each recognized. Then, the relative distance therebetween is measured by a measuring instrument (not shown), and adjusted to a preset distance, to thereby perform the alignment.

In the present invention, the intensity of the light irradiated onto the reflective member 107 and the intensity of the light irradiated onto the mask sheet 103 located therearound are substantially the same. Therefore, the intensity difference between the light reflected by the reflective member 107 and the light reflected by the mask sheet 103 may be replaced with a reflectance difference between the reflective member 107 and the mask sheet 103. At this time, unless the reflectance difference therebetween is 15% or more, an image having a contrast between the mask alignment mark and the periphery thereof may not be obtained through a CCD camera 101 having a standard sensitivity. In other words, the term “reflective member” herein employed refers to a member having a reflectance higher than that of the mask sheet 103 by 15% or more.

As described above, the mask sheet 103 is formed of iron, nickel, or an alloy thereof, which has a small coefficient of thermal expansion. A high-definition pattern employed for a production of an organic light-emitting device is formed by etching a sheet, and hence the reflectance of the surface of the mask sheet fluctuates within a range between 20% and 35%. When a standard light emitting diode (LED) lighting of about 1,500 luxes is employed, the reflectance of the reflective member is desirably higher than that of the mask sheet 103 by 15% or more, that is, 50% or more in this case.

The reflective member is desirably a member that is not easily deformed, and may include a member obtained by forming a material having a high reflectance, such as aluminum or silver, on a reflection surface of a glass or metal plate in order to increase the reflectance, or a member made of a metal plate which has a surface subjected to a smoothing process. With the surface of the reflective member which has been subjected to the smoothing process, the light irradiated to the reflective member is not irregularly reflected on the surface of the reflective member, and hence the reflected light having a high intensity may be sent back to the CCD camera. As a result, a detected position accuracy of the mask alignment mark 106 may be enhanced.

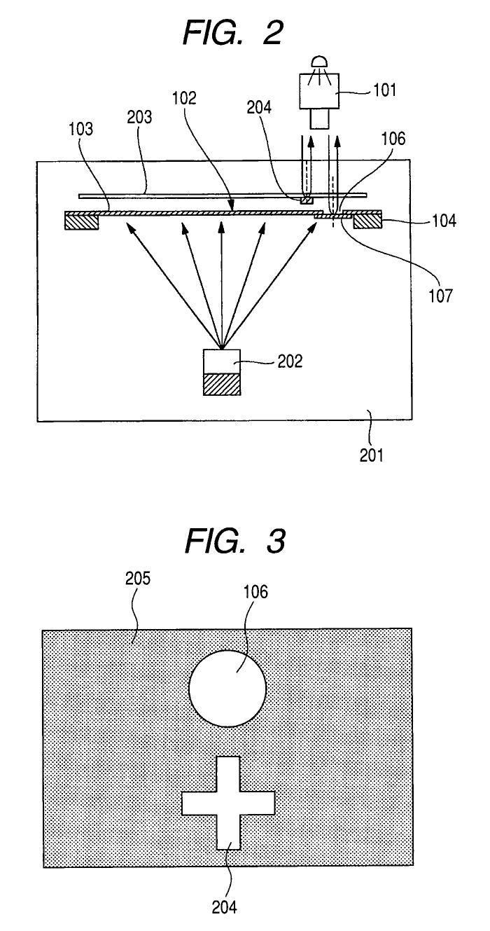

Though not illustrated in FIG. 2, the periphery of the film formation mask 102 is held by a mask holder. The mask holder is connected to a predetermined drive section. The drive section moves the film formation mask 102 based on the positional information on the film formation mask 102, which is obtained through the CCD camera 101, to position the film formation mask 102 and the substrate.

When the reflective member 107 is provided in contact with the mask sheet 103, the reflective member 107 may be always parallel to the mask sheet 103, and therefore the light reflected by the reflective member 107 may be reliably sent back to the CCD camera 101. As a result, the detected position accuracy of the alignment mark may be enhanced. In addition, the reflective member 107 blocks the positioning opening 106, and hence it may be prevented that a film is attached to the positioning opening 106 and the shape of the alignment mark is changed to lower the recognition accuracy.

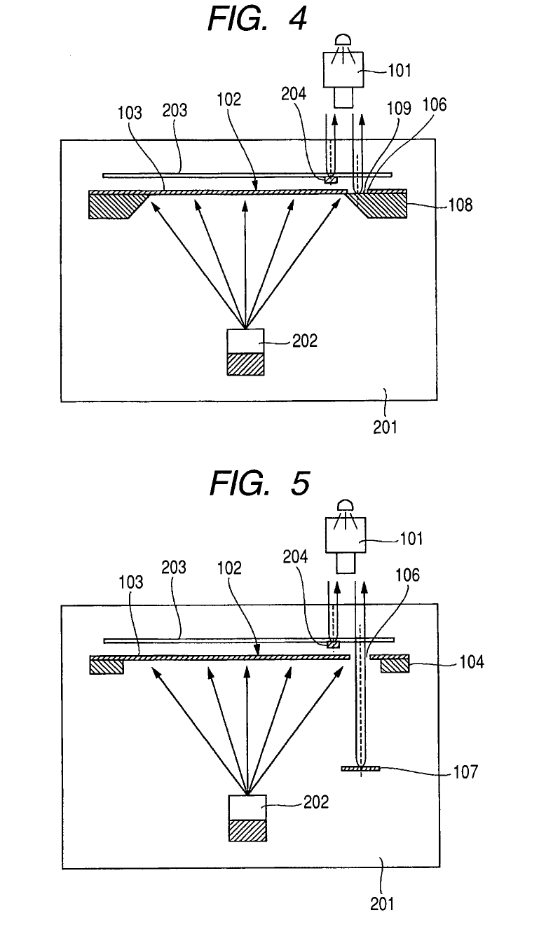

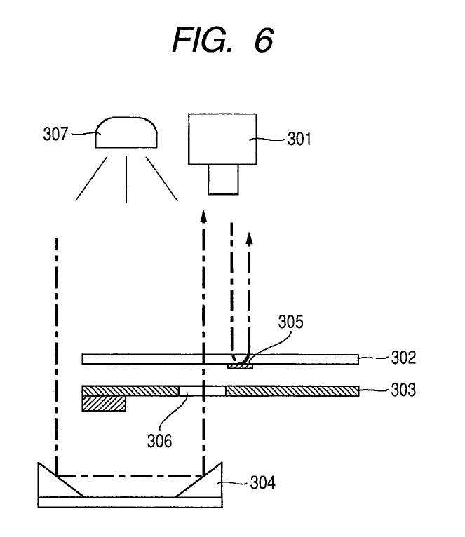

Next, a film formation mask according to another embodiment is described. As illustrated in FIG. 4, the positioning opening 106 is formed in a peripheral portion of the mask sheet 103, at a portion at which the mask sheet 103 and a mask frame 108 are in contact with each other. A reflection surface 109 for reflecting the light irradiated onto the positioning opening 106 during the alignment is provided on a surface of the mask frame 108 at a portion at which the mask frame 108 is in contact with the positioning opening 106. With this structure, the mask frame 108 also serves as the reflection surface 109, and hence the structure of the film formation mask may be simplified.

The reflection surface 109 of the mask frame 108 may be formed of a film made of Al or Ag having a high reflectance, but is desirably formed by subjecting the surface thereof to the smoothing process. With the surface of the reflection surface 109 which has been subjected to the smoothing process, the light from a light source is not irregularly reflected by the reflection surface 109, and hence the reflected light having a high intensity may be sent back to the CCD camera. As a result, a detected position accuracy of the mask alignment mark 106 may be enhanced.

As described above, owing to the reflective member thus provided, even when fluctuations of the reflectance of the mask sheet 103 occur during production steps, the reflectance difference between the mask sheet and the reflective member may be kept constant. Accordingly, the mask alignment mark image may be stably recognized to obtain an accurate positional information on the film formation mask 102.

### Example 1

FIG. 2 is a schematic view illustrating a film formation mask according to Example 1 of the present invention and a vacuum evaporation apparatus in which the film formation mask is disposed. Though omitted in FIG. 2, the multiple pattern opening portions are formed in the mask sheet 103.

A pattern including multiple vapor passage ports was formed by etching in the mask sheet 103 of the film formation mask 102 formed of an Invar material, which is an alloy of iron and nickel. In this case, the surface reflectance of the mask sheet 103 on the substrate 203 side was 30%.

A pair of the positioning openings 106 was formed in the peripheral portion of the mask sheet 103. In this example, a round hole having a diameter p of 0.5 mm was adopted as each of the positioning openings 106.

The reflective member 107 was provided on an evaporation source 202 side of the mask sheet 103 so as to be in close contact with the mask sheet 103. A mirror obtained by forming an aluminum thin film on a glass surface by sputtering was employed as the reflective member 107. The reflective member 107 was adhered to the mask sheet 103 through a graphite paste such that the mirror surface (the side of the reflective member 107 on which the aluminum thin film was formed) faced the mask sheet 103. The reflectance of the mirror surface at this time was 90%.

The film formation mask 102 as described above was placed with a mask holder (not shown) in a vacuum evaporation apparatus 201. The substrate 203 supported by a substrate holder (not shown) was placed above the film formation mask 102. Then, the film formation mask 102 and the substrate 203 were aligned with each other. Light was irradiated by a lighting through a window glass provided on a wall of the vacuum evaporation apparatus 201 from the outside of the vacuum evaporation apparatus 201. Image information on the positioning opening 106 of the mask and image information on a substrate alignment mark 204 were obtained through the CCD camera 101. An LED coaxial lighting of 1,300 luxes was employed as the lighting.

FIG. 3 illustrates an example of a CCD image 205 of the positioning opening 106 of the film formation mask according to this example. In this example, an image of the mask alignment mark 106 and an image of the substrate alignment mark 204 were both displayed on a monitor screen connected to the CCD camera 101.

Image data of the mask alignment mark 106 and image data of the substrate alignment mark 204 were processed by a computer, and a positional relationship therebetween was calculated. Then, a drive section (not shown) moved the film formation mask 102, to thereby perform the alignment.

In the case of the mask disclosed in Japanese Patent Application Laid-Open No. H11-158605, the shape and size of the mask mark, fluctuations of light amount due to a placement position of the light source, the surface state of the reflective plate, and the like normally affect the image information on the alignment mark 106 to be obtained. As a result, there was caused a disadvantage that an image state is slightly changed and the accuracy of the positional information calculated based on the slightly changed information fluctuates. On the other hand, according to the film formation mask 102 used in this example, the above-mentioned disadvantage was solved, and position accuracy with an excellent reproducibility was obtained. In addition, the influence of attachment of an evaporation substance generated by the evaporation source 202 on the mask alignment mark 106 was eliminated.

### Example 2

FIG. 4 is a schematic view illustrating a film formation mask according to Example 2 of the present invention and a vacuum evaporation apparatus in which the film formation mask is disposed. Components similar to those of Example 1 are identified by the same reference numerals, and description thereof is omitted. Though not illustrated in FIG. 4, similarly to Example 1, thirty-six pattern opening portions are formed in the mask sheet 103 in order to obtain thirty-six organic light-emitting panels at a time.

In FIG. 4, the positioning opening 106 was formed at a position at which the mask sheet 103 and the mask frame 108 are in contact with each other, in the peripheral portion of the mask sheet 103. Then, the surface of the mask frame 108 corresponding to a portion that is in contact with the positioning opening 106 was subjected to the smoothing process so that a reflection surface for reflecting the light irradiated onto the positioning opening 106 during the alignment was provided. In this example, the mask frame 108 was formed of stainless steel, and hence the reflectance of the reflection surface was 50%. The mask sheet 103 produced in the same manner as in Example 1 was used, and the reflectance of the mask sheet 103 on the substrate side was 32%. In this example, the surface of the mask frame 108, which has been subjected to the smoothing process, also serves as the reflective member of Example 1, and hence the reflective member 107 may be omitted. With regard to the effect of Example 2, the equivalent effect to that of Example 1 was obtained.

### Comparative Example 1

FIG. 5 is a schematic cross-sectional view illustrating a vacuum evaporation apparatus using a film formation mask according to Comparative Example 1 of the present invention.

In this comparative example, with the exception that the reflective member 107 was provided apart from the film formation mask 102, the same film formation mask 102 as that of Example 1 was used. The image of the mask alignment mark 106 was obtained to check the repetition position accuracy thereof.

In Examples 1 and 2 and Comparative Example 1, the image information on the mask alignment mark 106 was obtained by measurement performed by using CV-3500 (trade name; manufactured by Keyence Corporation). For the measurement, the LED coaxial lighting of 1,300 luxes was employed and disposed so as to irradiate the mask alignment mark from the CCD camera side. The measurement was performed at two points, and respective deviation amounts from a design value were evaluated. The alignment was performed with respect to ten substrates, and an average value of the position accuracy of the alignment results is shown in Table 1. Evaluation criteria are as follows:

A: Repetition position accuracy of the mask mark is 0 to 2 micrometers
B: Repetition position accuracy of the mask mark is 2 to 5 micrometers
C: Repetition position accuracy of the mask mark is 5 to 8 micrometers
D: Repetition position accuracy of the mask mark is equal to or larger than 8 micrometers.

TABLE 1

| | Repetition |
|---|---|
| | measurement accuracy |
| Example | of mask mark |
| Example 1 | A |
| Example 2 | A |
| Comparative Example 1 | C |

As can be seen from Table 1, in each of the film formation masks of Examples 1 and 2, the reflective member is provided, to thereby suppress a change in reflectance and to obtain a stable contrast. As a result, the detected position accuracy of the mask alignment mark was enhanced. Furthermore, an evaporation substance is prevented from attaching to and soil the mask alignment mark. As a result, degradation of the detected position accuracy, which is otherwise caused each time the evaporation is performed, was prevented.

According to the film formation mask of the present invention, a high detected position accuracy of the mask alignment mark is obtained with a simple mask structure, and enhancement in yield for a device production and enhancement in productivity such as reduction in production cost are achieved.

The present invention is suitably applied to a formation of an organic compound film of an organic light-emitting device, but is not limited thereto. As long as a thin film is formed on a substrate using a mask, the present invention may be applied without any particular limitation. For example, the present invention may be applied to film formation in which a substrate and a mask need to be aligned with each other by a evaporation process, a CVD process, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-251993, filed Sep. 30, 2008, and Japanese Patent Application No. 2009-207975, filed Sep. 9, 2009, which are hereby incorporated by reference herein in their entirety.

What is claimed is:

1. A film formation mask having openings for forming a film in a pattern on a substrate, comprising:
a mask sheet having openings formed therein;
a mask frame for fixing and supporting the mask sheet;
a positioning opening provided in the mask sheet; and
a reflective member disposed on a surface of the mask sheet, the surface being opposite to a surface of the mask sheet that faces a substrate, the reflective member blocking the positioning opening,
wherein a reflectance of the reflective member is larger than a reflectance of the mask sheet.

2. The film formation mask according to claim 1, wherein the reflective member is attached to the mask sheet.

3. The film formation mask according to claim 1, wherein the mask frame also serves as the reflective member.

4. The film formation mask according to claim 3, wherein a surface of a part of the mask frame also serving as the reflective member is subjected to a smoothing process.

5. A film formation method using the film formation mask set forth in claim 1, comprising the steps of:
irradiating the reflective member of the mask sheet with light;
recognizing the light reflected by the reflective member as an image;
calculating a position of the film formation mask based on the image;
aligning a position of the substrate with the position of the film formation mask based on the calculated position; and
forming a film on the substrate.
